(19) United States
(12) Patent Application Publication
(10) Pub. No.: US 2016/0376809 A1
(43) Pub. Date: Dec. 29, 2016

(54) Headstone Halo

(71) Applicant: James Harold McPeak, Culpeper, VA (US)

(72) Inventor: James Harold McPeak, Culpeper, VA (US)

(21) Appl. No.: 15/192,117

(22) Filed: Jun. 24, 2016

Related U.S. Application Data
(60) Provisional application No. 62/231,156, filed on Jun. 25, 2015.

(51) Int. Cl. E04H 13/00; F21V 21/088; F21V 3/02; F21V 33/00; F21V 3/04

(52) U.S. Cl. CPC E04H 13/001; F21V 33/0004; F21V 3/0436; F21V 3/02; F21V 21/088; F21W 2121/00

(57) ABSTRACT

This invention relates to a device for illuminating a headstone. This provides illumination to locate the headstone, and decoration to distinguish the headstone.

### BACKGROUND

Deceased loved ones are traditionally buried in a grave in the ground with a headstone to mark the location of the site. Headstones typically contain written inscriptions eulogizing the individual who is interred beneath, and are typically decorated with flowers or other adornments when loved ones visit the site. It would be useful to have a way of illuminating a headstone as a means to locate a particular headstone in the dark, and as a means of distinguishing a particular headstone from others.

### SUMMARY

This invention relates to a device for decorating and illuminating a headstone. This device allows a person to quickly locate a particular headstone.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is an overhead view of a particular embodiment of the device.

FIG. 2 is a side view of a particular embodiment of the device.

FIG. 3 is a view of a particular embodiment of the device in use.

### DETAILED DESCRIPTION

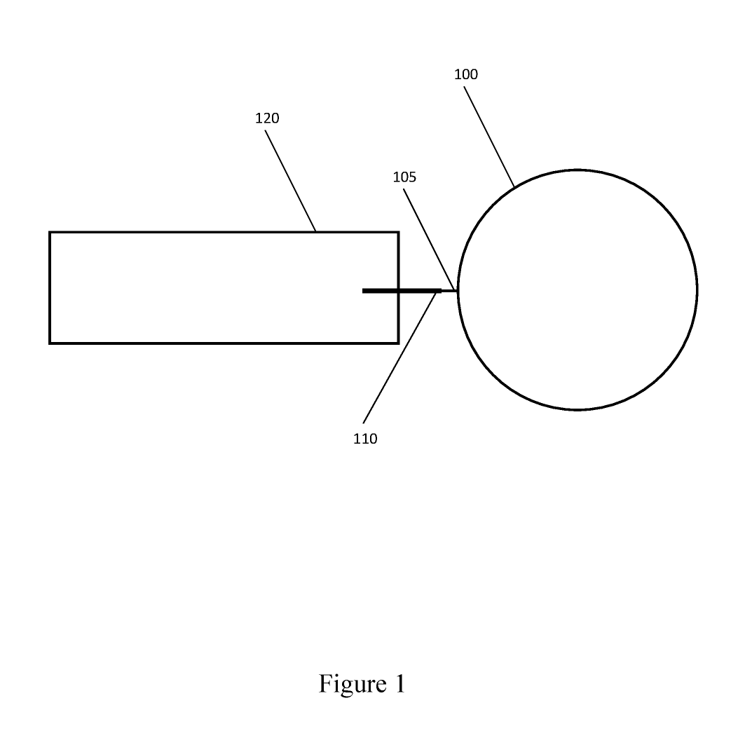

In the particular embodiment illustrated in FIG. 1, halo 100 is a circular ring that is composed of plastic that has been treated to glow in the dark, with a mounting extension 105. Mounting extension 105 is a fixed protrusion from halo 100 that allows halo 100 to be mounted. Halo 100 is attached to stem 110 by means of one end of stem 110 being fitted over the mounting extension 105.

Stem 110 is a short sleeve or tube that is composed of stainless steel or other appropriate material. Stem 110 has a hollow, circular cross-section. Stem 110 is bent into an elbow shape at an approximately 90 degree angle. One end of stem 110 is connected to mount 120 by any means appropriate for such connection, such as a clamp, or soldering.

Mount 120 is an adjustable, interlocking clamp composed of metal or plastic. Mount 120 is sized such that it will fit over the majority of typical-sized grave headstones.

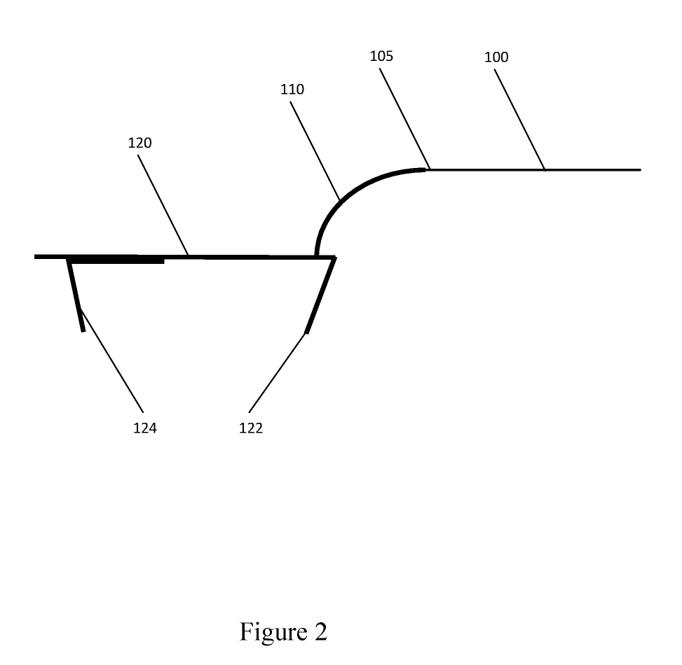

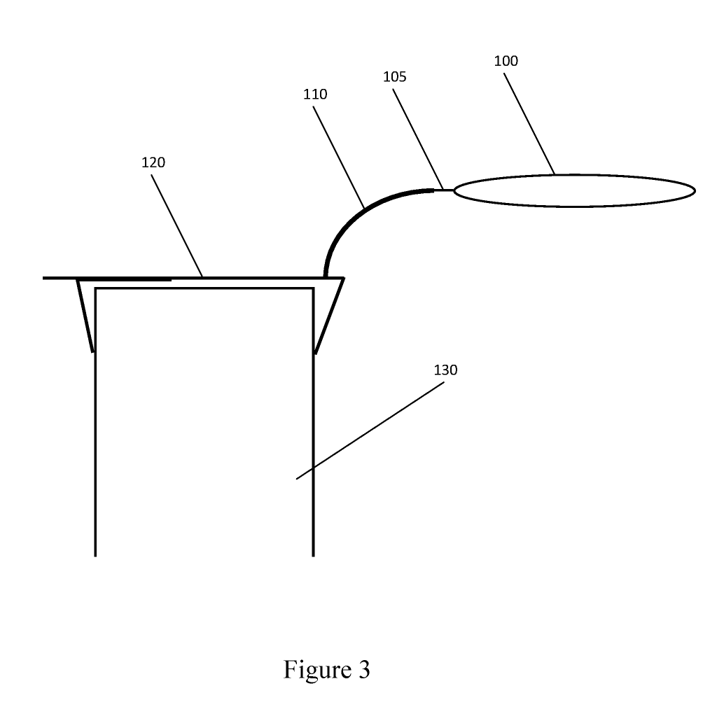

As shown in FIG. 2, mount 120 is composed of bracket 122 and bracket 124. Bracket 122 is a fixed piece of metal or plastic, shaped into an “L”, with an angle that is near 90 degrees. Bracket 124 is a piece of metal or plastic shaped into an “L”, with an angle that is near 90 degrees. Bracket 124 is attached to the underside of bracket 122 in such a manner that bracket 124 can slide along the length of bracket 124. Bracket 122 can also be fixed into place so as to form a clamp that affixes mount 120 into place, as shown in FIG. 3 where mount 120 is clamped onto headstone 130.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A device comprising:
a halo composed of flexible material that emits visible light;
a mount that is capable of being affixed to a grave headstone;
a connector with two ends that is attached to the mount at one end and the halo at the other end.
